(19) United States
(12) Patent Application Publication
(10) Pub. No.: US 2016/0025497 A1
(43) Pub. Date: Jan. 28, 2016

(54) PRE-CACHING OF NAVIGATION CONTENT BASED ON CELLULAR NETWORK COVERAGE

(71) Applicant: Harman International Industries, Incorporated, Stamford, CT (US)

(72) Inventors: Arvin Baalu, Bangalore (IN); Praveen Kumar Kammara, Hyderabad (IN)

(21) Appl. No.: 14/808,440

(22) Filed: Jul. 24, 2015

(30) Foreign Application Priority Data
Jul. 24, 2014 (IN) 3625/CHE/2014

(51) Int. Cl. G01C 21/00; H04W 8/02; H04L 29/08; G01C 21/34; H04W 4/04

(52) U.S. Cl. CPC G01C 21/005; G01C 21/34; H04W 4/046; H04L 67/12; H04W 8/02; H04W 84/042

(57) ABSTRACT

Embodiments are disclosed for caching navigation content. An example navigation system includes map data memory, a position sensor that determines the present location of the navigation system and provides a navigation system position signal indicative thereof, a wireless transmitter that transmits the navigation system position data, and a wireless receiver that receives cellular data including cellular white spot map data and cellular non-white spot map data in response to the transmitted navigation system position data and stores the received cellular white spot map data and the cellular non-white spot map data in the map data memory. The example navigation system also includes a processor that receives the navigation system position signal and forms a map image based upon received cellular white spot map data when the wireless receiver is not receiving cellular data.

### CROSS REFERENCE TO RELATED APPLICATIONS

The present application claims priority to Indian Provisional Patent Application No. 3625/CHE/2014, entitled “PRE-CACHING OF NAVIGATION CONTENT BASED ON CELLULAR NETWORK COVERAGE,” and filed on Jul. 24, 2014, the entire contents of which are hereby incorporated by reference for all purposes.

### FIELD

The present disclosure relates to the field of navigation systems, and in particular to a navigation system with caching of navigation content associated with wireless (e.g., cellular) white spots (e.g., zones that do not have cellular data coverage).

### BACKGROUND

On-line navigation solutions such as those provided by Google™ are becoming quite popular as an alternative to embedded navigation solutions found in infotainment systems for automobiles and in GPS units. A key advantage of an online navigation system is that the database is located in the cloud, and as a result the database can be updated at a single location with the latest infrastructure changes or latest traffic information available. However, an inherent weakness with an online navigation solution is that it is reliant on a constant connection to the cloud. The online navigation system is constantly pulling map/traffic/guidance data from the servers and presenting it (e.g., displaying it) to the user. This reliance on such an always-connected system is often not practical, since wireless network coverage is not ubiquitous. To mitigate the impact that wireless/cellular white spots have on the operation of online navigation systems, navigation content may be cached ahead of time based upon a known route corridor. However, many caching techniques lack intelligence and are bound by memory constraints.

### SUMMARY

Embodiments are disclosed for caching map data. An example navigation system that caches map data associated with wireless (e.g., cellular) white spots includes map data memory, a position sensor that determines a present location of the navigation system and provides navigation system position data indicative thereof, a wireless transmitter that transmits the navigation system position data, and a wireless receiver that receives wireless data including white spot map data and non-white spot map data in response to the transmitted navigation system position data and stores the received white spot map data and the non-white spot map data in the map data memory. The navigation system also includes a processor that receives the navigation system position signal and forms a map image based upon the received wireless white spot map data and the navigation system position data when the wireless receiver is not receiving the wireless data. The processor may form the map image based upon the received wireless non-white spot map data when the wireless receiver has established a wireless communication channel to receive the wireless data. The processor may form the map image based upon the received wireless white spot map data when the navigation system position signal indicates that the navigation system is within the area defined as a wireless white spot based upon wireless white spot location data.

An example method of caching, in a navigation system map data memory device, navigation content that is associated with cellular white spots includes determining a present location of the navigation system and providing a vehicle position signal indicative thereof, wirelessly transmitting the navigation system position data, and wirelessly receiving cellular data that comprises cellular white spot map data and cellular non-white spot map data in response to the transmitted navigation system position data, and storing the received cellular white spot map data and the cellular non-white spot map data in the map data memory device. The example method further includes forming a map image based upon received cellular white spot map data and the navigation system position signal, when the wireless receiver is in a cellular white spot.

An example in-vehicle computing system for caching map data includes one or more sensors, a network interface coupled to a cloud-based map database, a user input interface configured to receive user input from one or more user input devices, a processor, and a storage device storing map data and instructions executable by the processor to determine a current location based on inputs from the one or more sensors. The instructions may further be executable to receive a destination input from a user via the one or more user input devices, determine a route based on the current location and the destination, generate a map image of the route, determine a number of white spots along the route, and download white spot map data, an amount of white spot map data that is downloaded being based on the number of white spots along the route.

It is to be understood that the features mentioned above and those to be explained below can be used not only in the respective combinations indicated, but also in other combinations or in isolation. These and other objects, features, and advantages of the invention will become apparent in light of the detailed description of the embodiment thereof, as illustrated in the accompanying drawings.

### BRIEF DESCRIPTION OF THE DRAWINGS

The foregoing and other features of embodiments will become more apparent from the following detailed description of non-limiting embodiments when read in conjunction with the accompanying drawings. In the drawings, like or identical reference numerals refer to like or identical elements.

FIG. 1 shows an example interior view of a cabin of a vehicle including an in-vehicle computing system in accordance with one or more embodiments of the present disclosure;

FIG. 2 shows a block diagram of an example in-vehicle computing system in accordance with one or more embodiments of the present disclosure;

FIG. 3 shows a block diagram illustration of a navigation system with caching of navigation content associated with cellular white spots in accordance with one or more embodiments of the present disclosure;

FIG. 4 shows a block diagram illustration of a various units executed within the processor of the navigation system illustrated in FIG. 3 that communicate wirelessly with a navigation data server in accordance with one or more embodiments of the present disclosure;

FIG. 5 shows a pictorial illustration of a plurality of tiles of a map wherein each tile uniquely represents an x, y coordinate on the map in accordance with one or more embodiments of the present disclosure;

FIG. 6 is a flow chart of an example method for forming a map image based on received white spot map data in accordance with one or more embodiments of the present disclosure;

FIG. 7 is a flow chart of an example method for downloading map data based on a destination input by a user in accordance with one or more embodiments of the present disclosure; and

FIG. 8 schematically shows example routes and associated data downloads in accordance with one or more embodiments of the present disclosure.

### DETAILED DESCRIPTION

As described above, on-line navigation solutions rely heavily on a constant connection to the cloud. However, this reliance is often not practical, since the wireless network coverage changes quite drastically with location. Wireless (e.g., cellular) white spots include areas where wireless (e.g., cellular) network coverage is not available and/or is below a threshold performance parameter (e.g., signal strength, available bandwidth/throughput rate, etc.). Caching navigation content ahead of time based on the route is one way to mitigate the impact that wireless (e.g., cellular) white spots have on the operation of online navigation systems. In order to perform more intelligent caching that provides for a more efficient use of resources, the present disclosure describes a navigation system that communicates via a wireless data network to increase tolerance to wireless (e.g., cellular) white spots.

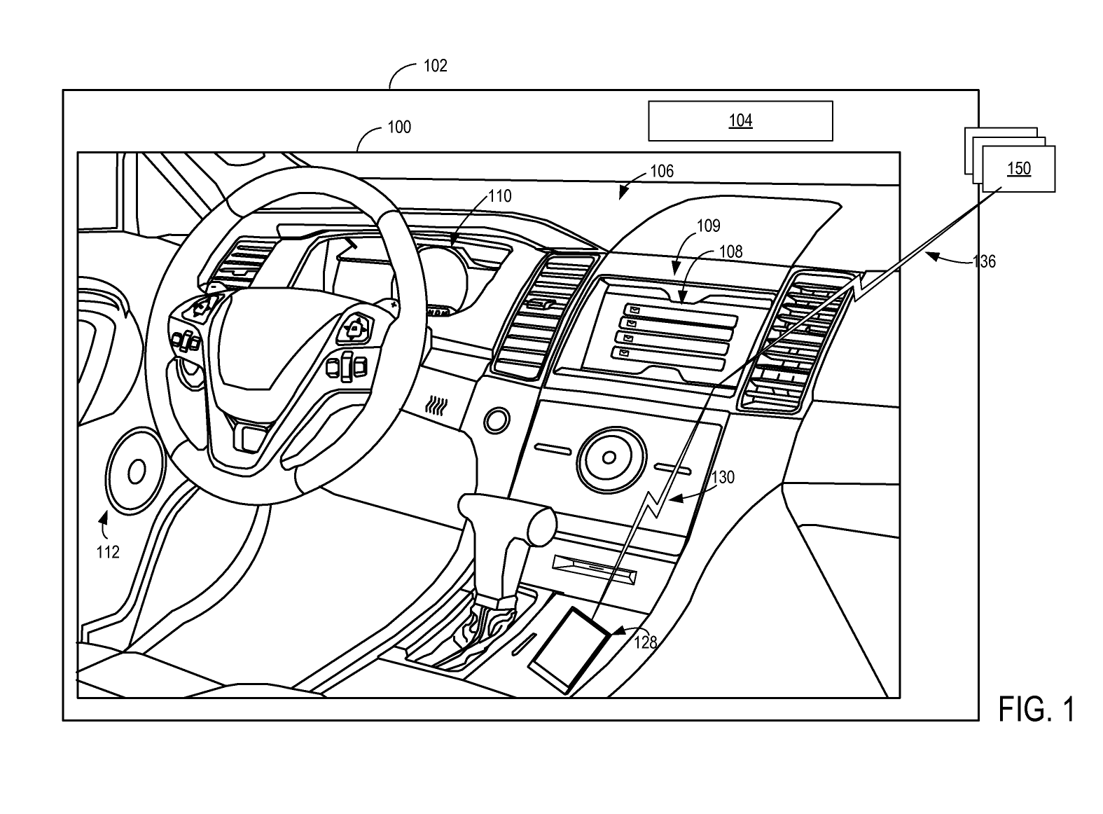

FIG. 1 shows an example partial view of one type of environment for a navigation system that caches wireless white spot data: an interior of a cabin 100 of a vehicle 102, in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a driver (also referred to as the user) of vehicle 102. For example, instrument panel 106 may include a touch screen 108 of an in-vehicle computing system 109 (e.g., an infotainment system), an audio system control panel, and an instrument cluster 110. While the example system shown in FIG. 1 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128.

In some embodiments, one or more hardware elements of in-vehicle computing system 109, such as touch screen 108, a display screen, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system may be modular and may be installed in multiple locations of the vehicle.

The cabin 100 may include one or more sensors for monitoring the vehicle, the user, and/or the environment. For example, the cabin 100 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 100, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108.

In-vehicle computing system 109 may analyze the input received from external devices 150, mobile device 128, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150. In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

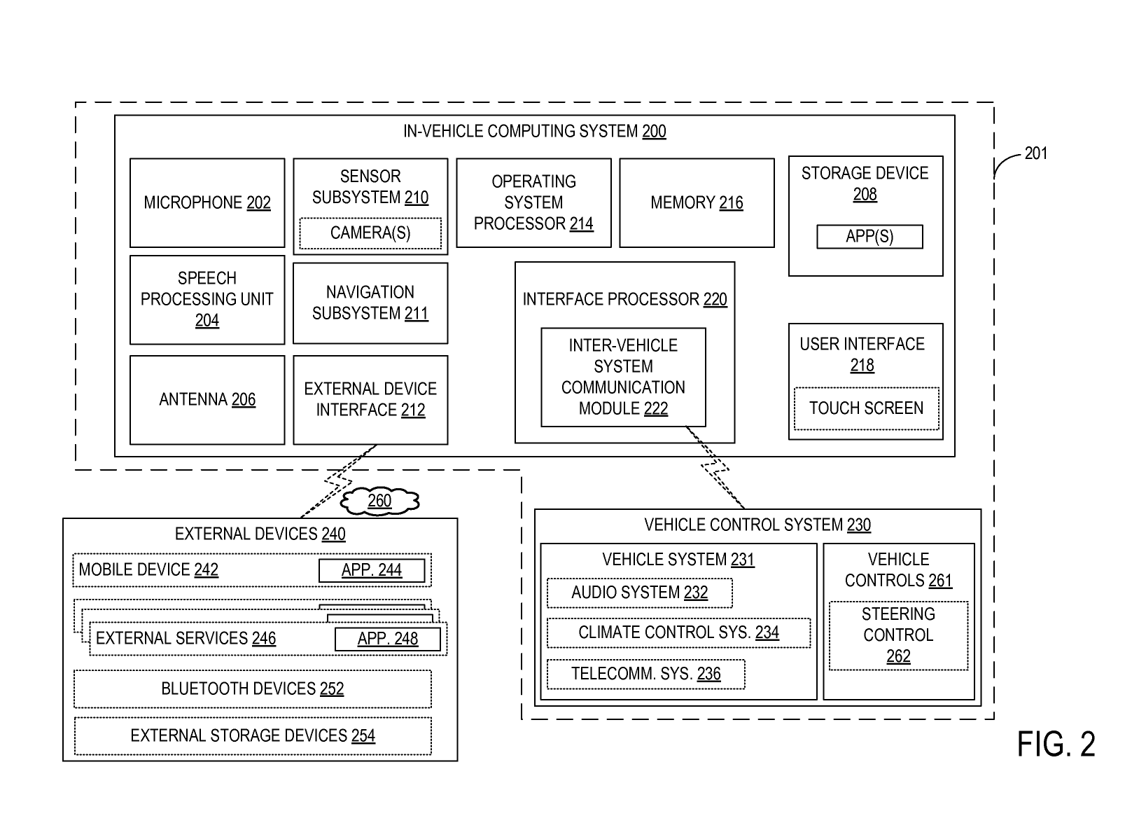

FIG. 2 shows a block diagram of an in-vehicle computing system 200 configured and/or integrated inside vehicle 201. In-vehicle computing system 200 may be an example of in-vehicle computing system 109 of FIG. 1 and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 201 in order to enhance an in-vehicle experience for a driver and/or a passenger.

In-vehicle computing system 200 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 200 to store data such as instructions executable by processors 214 and 220 in non-volatile form. The storage device 208 may store application data to enable the in-vehicle computing system 200 to run an application for connecting to a cloud-based server and/or collecting information for transmission to the cloud-based server. The application may retrieve information gathered by vehicle systems/sensors, input devices (e.g., user interface 218), devices in communication with the in-vehicle computing system (e.g., a mobile device connected via a Bluetooth link), etc. In-vehicle computing system 200 may further include a volatile memory 216. Volatile memory 216 may be random access memory (RAM). Non-transitory storage devices, such as non-volatile storage device 208 and/or volatile memory 216, may store instructions and/or code that, when executed by a processor (e.g., operating system processor 214 and/or interface processor 220), controls the in-vehicle computing system 200 to perform one or more of the actions described in the disclosure.

A microphone 202 may be included in the in-vehicle computing system 200 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 200 may also be able to receive voice commands and sample ambient vehicle noise using a microphone included in an audio system 232 of the vehicle.

One or more additional sensors may be included in a sensor subsystem 210 of the in-vehicle computing system 200. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 200 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 200 may generate and/or receive navigation information such as location information (e.g., via a GPS sensor and/or other sensors from sensor subsystem 210), route guidance, traffic information, point-of-interest (POI) identification, and/or provide other navigational services for the driver.

External device interface 212 of in-vehicle computing system 200 may be coupleable to and/or communicate with one or more external devices 240 located external to vehicle 201. While the external devices are illustrated as being located external to vehicle 201, it is to be understood that they may be temporarily housed in vehicle 201, such as when the user is operating the external devices while operating vehicle 201. In other words, the external devices 240 are not integral to vehicle 201. The external devices 240 may include a mobile device 242 (e.g., connected via a Bluetooth, NFC, WIFI direct, or other wireless connection) or an alternate Bluetooth-enabled device 252. Mobile device 242 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 240 may communicate with in-vehicle computing system 200 either wirelessly or via connectors without departing from the scope of this disclosure. For example, external devices 240 may communicate with in-vehicle computing system 200 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 242. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 242 from in-vehicle computing system 200 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, etc.) or other applications (e.g., navigational applications) of mobile device 242 to enable the requested data to be collected on the mobile device. Mobile device application 244 may then relay the collected information back to in-vehicle computing system 200.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers. Vehicle audio system 232 may be passive or active such as by including a power amplifier. In some examples, in-vehicle computing system 200 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 201. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 200, such as via communication module 222. The control elements of the vehicle control system may be physically and permanently positioned on and/or in the vehicle for receiving user input. In addition to receiving control instructions from in-vehicle computing system 200, vehicle control system 230 may also receive input from one or more external devices 240 operated by the user, such as from mobile device 242. This allows aspects of vehicle systems 231 and vehicle controls 261 to be controlled based on user input received from the external devices 240.

In-vehicle computing system 200 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via RF such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 240 (such as to mobile device 242) via external device interface 212.

One or more elements of the in-vehicle computing system 200 may be controlled by a user via user interface 218. User interface 218 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 200 and mobile device 242 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

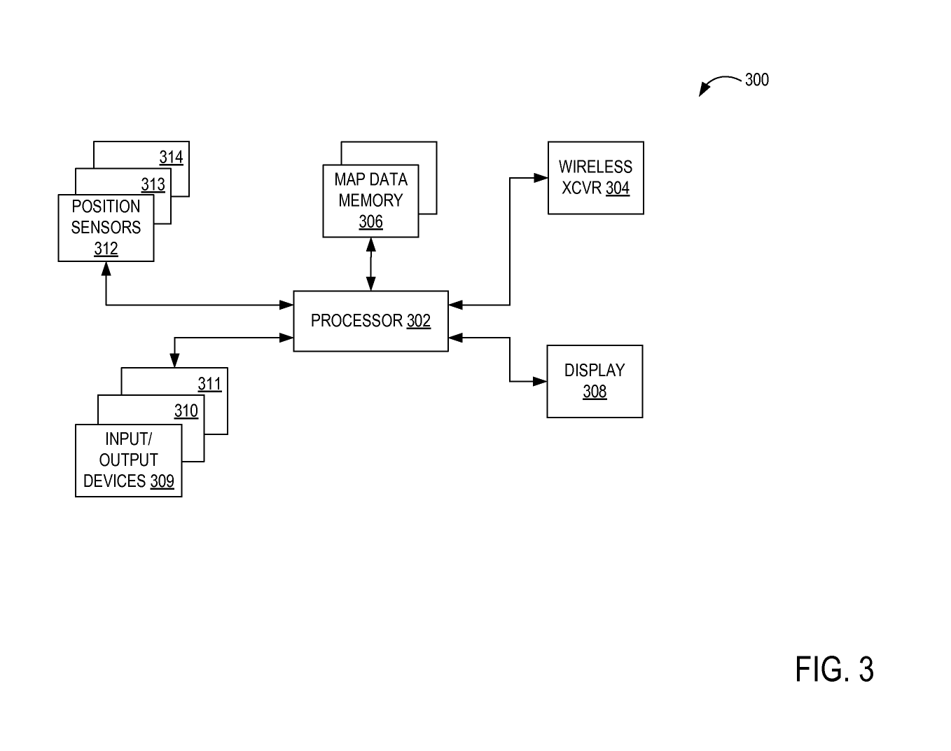

FIG. 3 is a block diagram illustration of an example navigation system 300 that caches navigation content associated with wireless (e.g., cellular) white spots. The system includes a processor 302, a cellular transceiver 304, memory, including map data memory 306, a display 308, a plurality of input/output devices 309-311 and a plurality of sensors 312-314. The navigation system may be configured for example as a handheld device, as a component of a motor vehicle navigation system (e.g., in-vehicle computing system 109 of FIG. 1/in-vehicle computing system 200 of FIG. 2), as a component of a smartphone, and/or as any other suitable computing device(s).

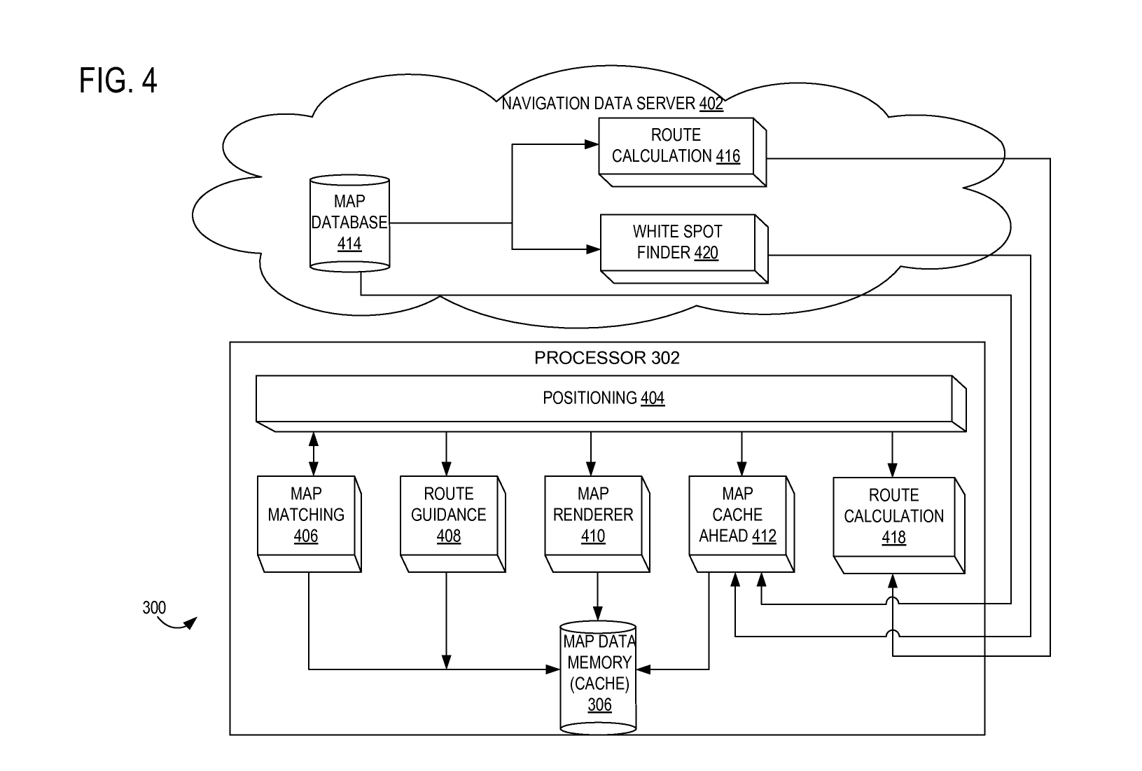

The cellular transceiver 304 (also referred to as wireless transceiver) may include a transmitter and a receiver and is generally capable of transmitting and receiving wireless signals, for example. The transmission and the reception may be done on the same frequency or on different frequencies, depending on the type of transceiver used. The transceiver 304 may send and receive signals from the processor 302. As such, the transceiver 304 may receive wireless data including wireless white spot data (e.g., locations/boundaries of wireless white spots, wireless network coverage parameters within a wireless white spot, etc.), wireless non-white spot data, etc. from a remote service, such as a cloud storage device located remotely from the navigation system and/or remotely from the device (e.g., the smartphone, handheld device, in-vehicle computing system, etc.) that includes the navigation system. In some examples the wireless transceiver 304 may receive route and/or white spot data (areas with no cellular data coverage, for example) information from a navigation data server. Upon receiving the wireless data, the transceiver 304 may send the received data to the processor 302, for processing and storing, which is described in detail with reference to FIG. 4.

Position sensors 312-314 may measure a current position and/or location of the navigation system and relay the position information to the processor 302. Position sensors 312-314 may include one or more of linear position sensors, angular position sensors, and multi-axis position sensors. Some examples of position sensors include capacitive transducer, capacitive displacement sensor, eddy-current sensor, GPS receiver, accelerometer, etc. The current location of the navigation system may be determined based on the output of the position sensors 312-314, for example. The position sensors 312-314 may additionally or alternatively, receive position information from the processor 302. As such, the processor 302 may communicate bi-directionally with the position sensors 302-304. Said another way, the processor may receive the position input from the position sensors 302-304. In example situations wherein there is no wireless coverage, or the position sensor is unable to determine the position, the processor may be able to retrieve a location information stored in the map memory data 306, for example, and transmit the location data to the position sensor. The processor 302 receives further input via input/output devices 309-311. Some examples of input devices may include keyboard, touch pad, joysticks, microphones, etc., and examples of output devices may include monitor, printer, etc. For example, a user may input a destination using the touch pad of device 309 overlaid on display device 308, and the display device 308 may display several options for selection on the monitor, for example.

The processor 302 may receive a current location from the position sensors 312-314, receive wireless white spot data information from the wireless transceiver 304, receive a destination input from the user using plurality of input/output devices 309-311, and may generate a map data, which is then stored in the map data memory 306. As such, the map data may include white spot data and non-white spot data. Furthermore, the map data may include a map of the route generated, for example. In some examples, the route may be displayed on the display 308 (e.g., including a touchscreen, monitor, etc.). In situations when there is no cellular coverage (marked as cellular white spots), the processor 302 may retrieve the map from the map data memory 306. The processor 302 may further cache the processed map along with the additional data relating to the white spots and non-white spots in the map as described in detail with reference to FIG. 4.

FIG. 4 is a block diagram illustration of various exemplary functional units executed within the processor 302 illustrated in FIG. 3. The navigation system 300 wirelessly communicates with a navigation data server 402 (e.g., Google™ Maps), via for example the wireless transceiver 304 (FIG. 1), to download map data from the navigation data server 402 based upon the location information provided by the navigation system 300 to the server 402.

The processor 302 includes a positioning unit 404, which keeps track of the current location of the navigation system based upon inputs from the plurality of sensors 312-314 (FIG. 3). A map matching unit 406 receives position data from the positioning unit 404, and for example aligns the navigation system position with the road network and feeds back the aligned position to the positioning unit 404 by triangulation, for example. Route guidance unit 408 receives position data from the positioning unit 404 and provides turn-by-turn guidance to a selected destination from the current position of the navigation unit 300, where the destination may be input by the user using the plurality of input/output devices (309-311) shown in FIG. 3. Map render unit 410 also receives position data from the positioning unit 404 and identifies required map images or tiles and/or vector data stored in map data memory 306. As such, the map image may include tiles of map data stacked together to generate the map image. In one example, the map image may include 25 map tiles. However, the number of map tiles generated may depend on the physical memory size of the navigation device, for example. The map cache ahead unit 412 downloads map data from server side map database 414, which is located remote from the navigation device 300. The map database 414 is located in the navigation server 402 (also referred to as the cloud). The download to the navigation device 300 may be via the cellular transceiver 304 (FIG. 3), and based upon the current position and direction of movement of the navigation system 300.

Having the map database 414 in the cloud offers several advantages. With the map database 414 located in the cloud, the database for a geographic region can be maintained and updated at a single location (or a few locations) with the latest infrastructure changes or latest traffic information available, and is available to a plurality of navigation system users. Said another way, the cloud may include map data that is available to a number of users, thereby providing ready user-access to the map database.

The navigation server 402 also includes a route calculation unit 416 that receives data indicative of the current position (determined by the position sensors, for example) of the navigation system 300 and data indicative of a selected destination. The selected destination may be input, for example, by a user via input devices (e.g., a touchscreen screen), by an audio input indicative of the selected destination, et cetera. In response to the current position and specified location, the route calculation unit 416 of the navigation data server 402 calculates and provides route data to a client side route calculation unit 418, located on the navigation device 300. When the navigation device 300 has a wireless data connection to the navigation server 402 (e.g., via the cellular transceiver 304 illustrated in FIG. 3), then the client side route calculation unit 418 uses the route calculation data from the server side route calculation unit 416. However, when a data connection to the navigation server 402 is not available, then the client side route calculation unit 418 calculates and provides data indicative of the route between the current location and the specified destination.

The navigation server 402 also includes a white spot finder location unit 420, which receives map data, and based upon the current location and a destination when specified, requests additional map data from the server side map data memory 414 based upon the location of known white spots. White spots are locations that do not have cellular data coverage. White spots may further include regions or locations where the wireless connectivity or wireless signal strength is below a threshold (−90 dBm, for example). White spots may also be referred as “dead zones” or “dead spots”. Wireless signals are typically radio waves, and when these waves are interfered with or obstructed, wireless “dead zones” are generated. As such, wireless signals may not penetrate these dead zones. Typically, the wireless network coverage information is available from cellular companies (e.g., AT & T, Verizon, or T-Mobile) and therefore the white spot locations may be determined by looking up the network coverage data, for example. Furthermore, the white spot locations may be learned based upon the operational experience of the navigation device 300. When a destination is known to the navigation system, then the white spot finder location unit 420 may also use this information, in addition to the current location, to determine what white spot are along the route and then provide map data for the white spots along the route. Even when a destination is not known to the navigation system 300, then based upon the current location of the navigation device and the white spot locations known to the white spot finder 420, the white spot finder location unit may provide additional map data to the navigation device 300 for storage in the map data memory or cache 306. This ensures that even when the navigation device is travelling in a cellular white spot that map data is available to the user for guidance or situational awareness.

When a destination has not been specified to the navigation device 300, then the device may use stored data indicative of previous trips to determine the likely route along which the navigation system may travel. For example, a user may not specify a destination when travelling along a regular morning commute route, but based upon the starting location (e.g., a home location), day, and time of day, the navigation device may determine that it is probable that the navigation device will travel along a regular morning commute route to a known destination. In this case, the white spot finder location unit 420 may download a smaller set of map data associated with fewer white locations around the current location, since it is likely that the navigation device will travel along the regular commuting route. Similarly if a destination is not known at the navigation device 300, or if the navigation device does not have confidence that a known route is likely to be traversed based upon factors such as starting location, day, time of day, et cetera, then the white spot finder location unit 420 may provide map data associated with more white spots surrounding the current location of the navigation system to ensure the device has the map data for a white spot before the navigation device enters the white spot.

Since map data does not change that often, once the navigation system 300 has downloaded map data associated with known white spots, the map data is available in the client side map memory 306 for subsequent trips until over written. Of course if the client side map memory is large, then it reduces the amount of map data that may be required to be downloaded since the map data has previously been downloaded during previous trips. The size of the client side memory device versus the expected cost associated with downloading map data from the server is a system design trade-off. For example, if navigation data memory is less expensive than the cost of data over the wireless channel, then this would be a factor in making the client side/navigation device map memory device larger. This map caching intelligence based upon cellular white spots reduces the size of the client side map device since in one embodiment only white spot map data must be cached.

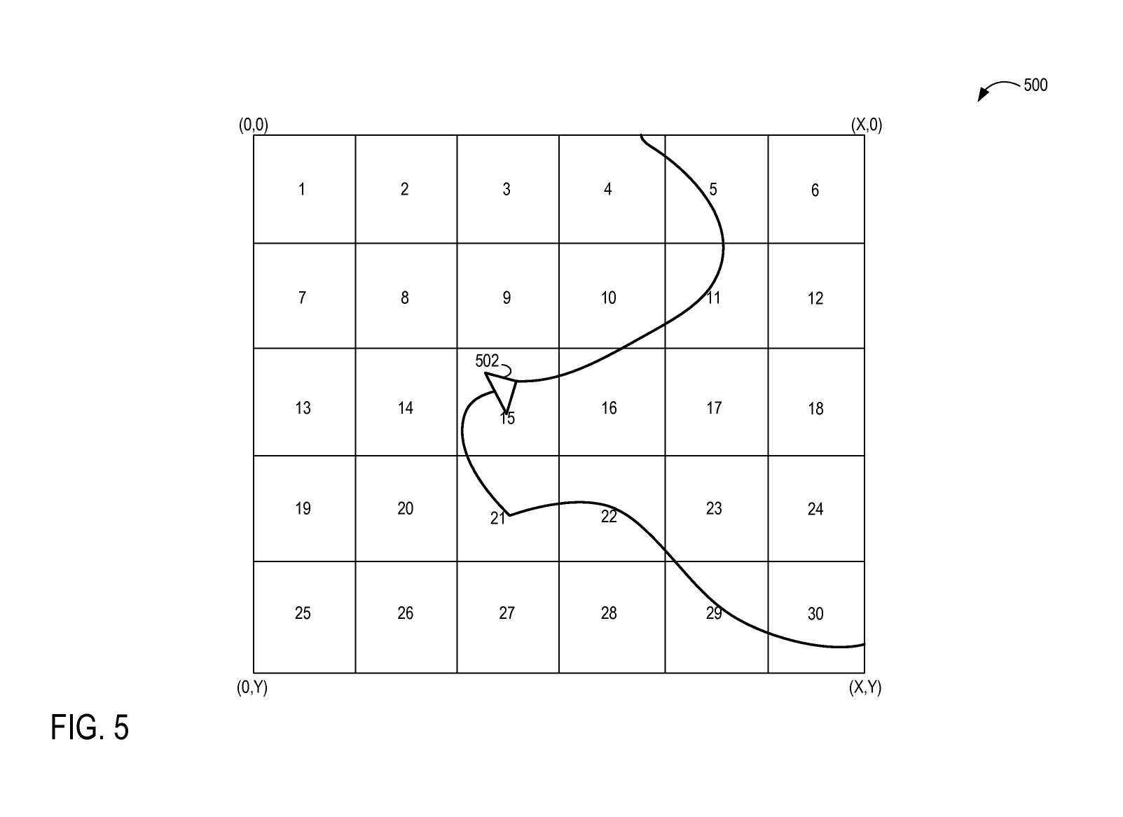

FIG. 5 is a pictorial illustration 500 of a plurality of tiles (e.g. numbered 1-24 in FIG. 5) of a map representation, wherein each tile contains map data uniquely indicative of an associated x, y coordinate on the map. A current location of the navigation device 300 (FIG. 3) is centered in the view port and illustrated as icon 502. If the current location of a route is centered on the viewport, then the client side map memory 306 (FIGS. 3-4) may be configured to have all the tiles around the centered tile to fill the viewport with map data. In one embodiment, if the viewport size is 1024×768 and tile size is 256×256 pixels then the cache may be configured to have (e.g., download/store/display) for example 5×5 tiles around the current location in order to handle both landscape and portrait mode of the device. For example, referring to FIG. 5, if tile 15 is to be centered in the viewport, then the navigation device may be configured to have (e.g., download/store/display) tiles #1-5, 7-11, 13-17, 19-23 and 25-29. In general, the navigation device 300 caches all the tiles required to fill the viewport throughout the route in the white spot at the zoom level used for turn by turn navigation view. If data usage and navigation device memory size is not a constraint, then the navigation system can download the required tiles at all the zoom tiles. The white spot caching technique provides for a smoother user experience.

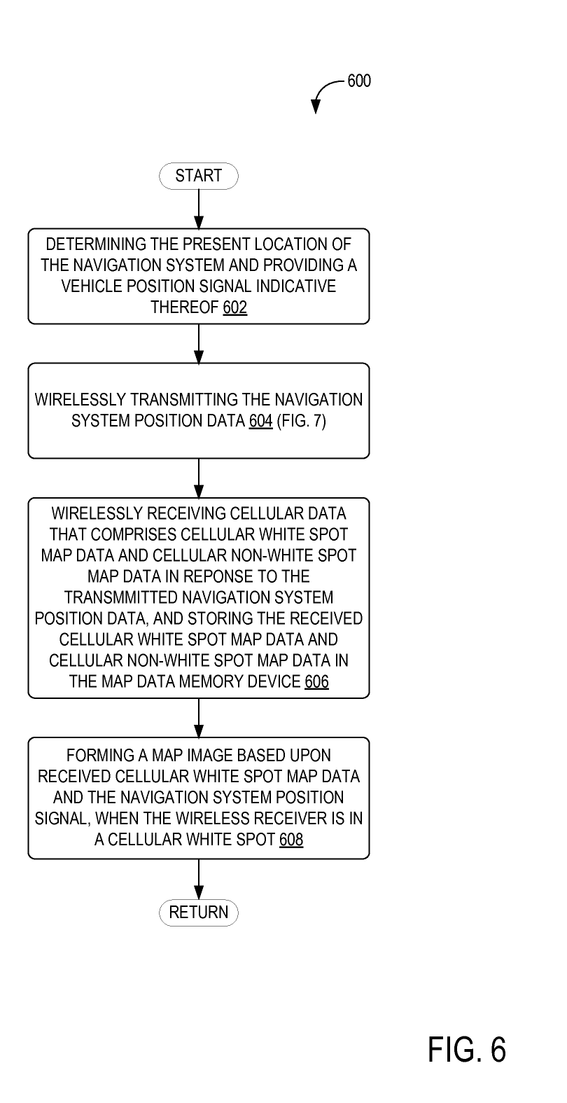

FIG. 6 shows a method 600 for forming a map image. For example, method 600 may be performed by the navigation processor illustrated in FIG. 3. At 602 the processor (e.g., processor 302 of FIG. 3) determines the present location of the navigation system based upon information from the position sensors, and provides a vehicle position signal indicative thereof. Next at 604, the navigation device (e.g., navigation device 300 of FIG. 3) wirelessly transmits the navigation system position data via the cellular transceiver (e.g., cellular transceiver 304 of FIG. 3). Next at 606, the navigation device wirelessly receives cellular data via the cellular transceiver that comprises cellular white spot map data and cellular non-white spot map data in response to the transmitted navigation system position data, and stores the received cellular white spot map data and the cellular non-white spot map data in the map data memory device. Then at 608, navigation device forms a map image based upon received cellular white spot map data and the navigation system position signal, when the wireless receiver is in a cellular white spot. In this way, the navigation device intelligently caches map data based associated with known cellular white spots prior to the navigation device entering the cellular white spot, thus ensuring that the device user has a proper map view while in the cellular white spot.

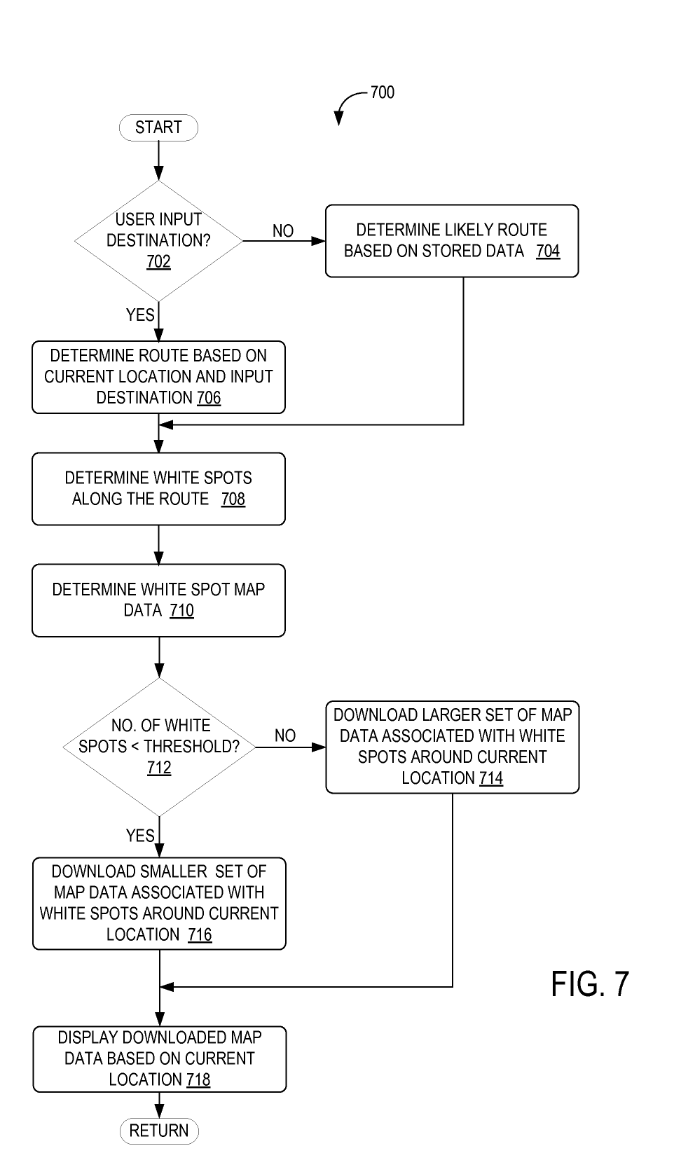

FIG. 7 is a flow chart of a method 700 for downloading map data based on a destination input. For example, method 700 may be performed by the navigation system processor 302 illustrated in FIG. 3 based on the destination input by the user using one or more of the input/output devices 309-311 of FIG. 3. Method 700 includes, at 702 determining if the user has input the destination. In one example, the user may input the destination using a touchpad of the navigation system. Specifically, the input destination may be received by the positioning unit of the processor. In addition, the positioning unit may also receive the current location based on the output of one or more of the position sensors. As explained earlier with reference to FIG. 4, the map matching unit may receive the position data from the positioning unit and further align the navigation system with reference to the road network, for example. This aligned position may then be transmitted to the positioning unit.

If the user did not input a destination (e.g., “NO” at 702), then method 700 proceeds to 704, where a route may be determined based on previously stored map data and previous vehicle travel data, for example. Based on the current location, the navigation system may intelligently determine a route that is most likely to be travelled based on previously generated map data history, for example. Conversely, if the user input the destination (e.g., “YES” at 702), then method proceeds to 706 where a route is determined based on the current location (as determined from the position sensors) and the input destination. In some examples, the current location may also be input by the user using the plurality of input/output devices. As such the route map may be generated using navigation algorithms based on a cartographic database, for example. The method then proceeds to 708, where the white spots along the route are determined. As described above, the white spots may include locations that do not have cellular data coverage or locations where the wireless connectivity or wireless signal strength is below a threshold (−90 dBm, for example). Next, at 710, the method includes determining white spot map data. The white spot map data may include the white spots (e.g., a location/boundary of the white spots, parameters, such as signal strength, of the white spots, etc.) combined with the route map (e.g., mapped to locations on the route map).

At 712, the method includes determining if the number of white spots along the route is less than a threshold. The threshold may be based on an overlap between neighboring white spots regions, for example. The threshold may further be based on the size or area of the white spot regions in some examples. If there is extensive overlap between neighboring white spot regions along the route, then it is highly likely that there will be extended regions where there may not be a wireless or cellular coverage. Thus, if the number of white spots is not less than the threshold (e.g., “NO” at 712), then the method proceeds to 714 where a relatively larger set of map data may be downloaded (e.g., larger than the set of map data downloaded for fewer numbers of white spots/a number of white spots that is below a threshold). The navigation device intelligently downloads or caches a larger set of map data associated with the white spots around the current location and along the route for example. In this way, if the user decides to change the route options while in a white spot area, the device may still be able to calculate the route based on the downloaded map data.

Conversely, if the number of white spots are below the threshold (e.g., “YES” at 712), then method proceeds to 716, where a relatively smaller set of map data associated with the white spots around the current location and along the route is downloaded (e.g., smaller than the set of map data downloaded for greater numbers of white spots/a number of white spots that is above a threshold). When there are fewer white spots along the route, or lesser overlap between neighboring white spots, or smaller size of the white spots, then it is possible to connect to the wireless network if more map data is needed. Hence the navigation device may download fewer sets of map data. In some examples, the amount of map data downloaded may be a function of the number and/or individual/total size of white spots (e.g., such that the amount of downloaded data is increased as the number and/or individual/total size of white spots increases). In additional or alternative examples, the amount of map data downloaded may be a function of other features of the white spots, such as wireless signal strength in the white spots, distance between white spots, etc. For example, the effect of a given white spot on the adjustment of the amount of data downloaded may be weighted based on the size of the white spot, the signal strength of the white spot, the distance to adjacent white spots, etc. At 718, the method includes displaying the downloaded map data based on a current location of the vehicle/user. For example, the portion of the map data relating to a region within a threshold distance of the vehicle/user may be displayed, and the map may be continuously updated as the user drives along the route to display additional portions of the downloaded map data.

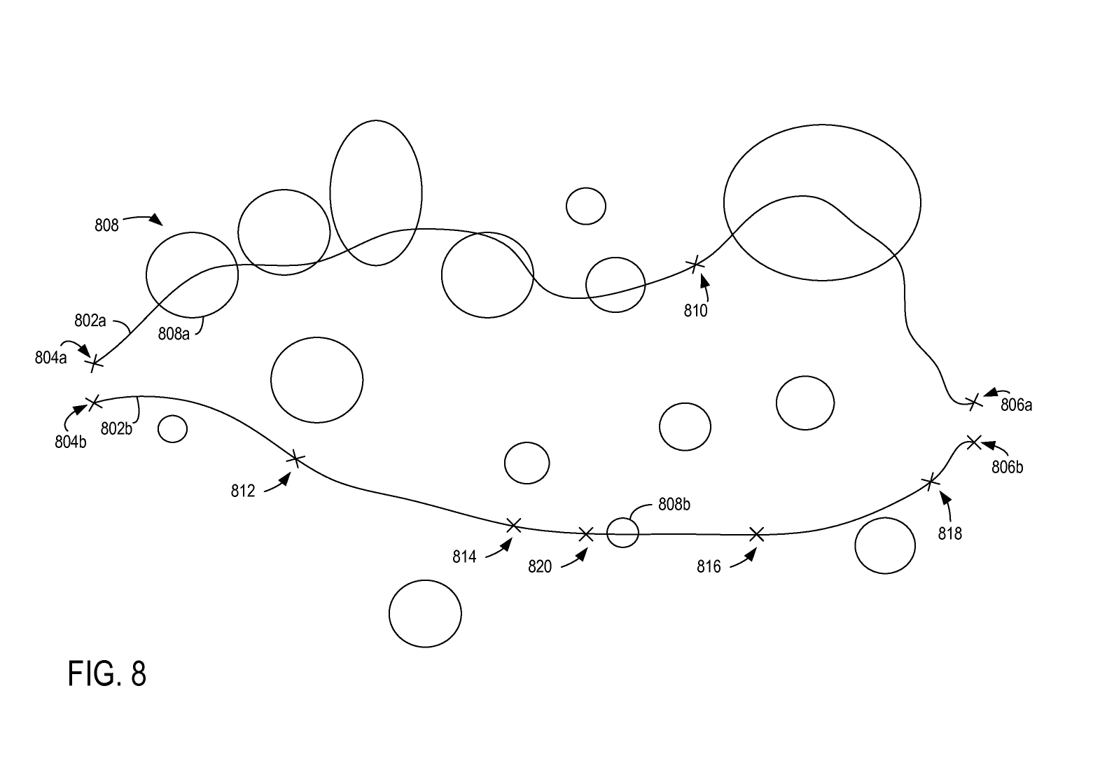

FIG. 8 schematically shows example data downloads that may be scheduled along example routes based on white spots along the routes. In a first example, a vehicle may travel along route 802a from starting point 804a to destination point 806a. In a second example, a vehicle may travel along route 802b from starting point 804b to destination point 806b. Along each of the routes, different numbers of white spots 808 may be present. The white spots may have any suitable shape and be included in a boundary (e.g., represented by the circumference of the circular/ovular shapes in FIG. 8). Although substantially rounded/regular shapes are shown in FIG. 8 for illustrative purposes, it is to be understood that white spots may have any suitable shape, including straight edges, irregular protrusions/recesses, etc.

The white spots may be considered to be “along” the route based on a proximity of the white spot and/or boundaries of the white spot to the route. For example, a white spot may be considered to be “along” the route if the white spot intersects the route (e.g., if the route travels into a boundary of the white spot) and/or if a boundary of the white spot is within a threshold distance of the route. In some examples, the threshold distance may be based on the size of the white spot, the proximity to other white spots, the posted/expected speed along the route, user preferences, and/or any other suitable factor. More generally, a given white spot may be counted as a white spot along the route based on any of the above-described or other suitable factors. For example, white spots that are smaller than a threshold size may not be counted as a white spot along a route regardless of its proximity to the route in some examples. In such examples, the threshold size may be based on the speed of the vehicle (e.g., the threshold size may increase as speed increases, since a vehicle travelling faster may be present in a white spot of a given size for a shorter amount of time than a vehicle travelling more slowly), the length of the route, the proximity of other white spots (e.g., decreasing as the number/distance of other white spots increases/decreases), etc.

Accordingly, route 802a may be considered to have a greater number of white spots along the route than route 802b. Based on the number of white spots along the route, a device in a vehicle at starting point 804a may receive a greater amount of map data (e.g., while at the starting point 804 and/or responsive to entering destination 806a and before entering a first white spot 808a) than a device in a vehicle at starting point 804b (e.g., a vehicle at starting point 804b that is determined to be traversing route 802b). For example, a device at starting point 804a that is determined to be traveling along route 802a may be controlled to download map data corresponding to locations within a threshold distance of the route for a section of the route spanning at least between starting point 804a and intermediate point 810 (e.g., to download that amount of map data while at starting point 804a and/or before entering white spot 808a). In some examples, the device may be controlled to download all map data within a threshold distance of route 802a between starting point 804a and destination point 806a (e.g., to download that amount of map data while at starting point 804a and/or before entering white spot 808a). In examples where the device is controlled to download map data within a threshold distance of the route 802a only between starting point 804a and intermediate point 810 (or some amount of data less than the complete route from starting point 804a and destination point 806a), additional map data corresponding to the remaining points of the route (e.g., a threshold distance from the route along the remaining portions of the route; e.g., map data within a threshold distance from the route between the starting point 804a and the destination point 806a that was not downloaded while at the starting point 804a, before entering white spot 808a, and/or before reaching intermediate point 810) may be downloaded to the device when the device reaches intermediate point 810 (e.g., as soon as the device reaches/in response to the device reaching intermediate point 810).

The location of the intermediate point may be determined responsive to evaluating the distribution of white spots along the route. For example, a length of the route (e.g., a length of a subsection of route 802a) that is greater than a threshold length and does not include any (or includes fewer than a threshold number of) white spots along that length of the route (e.g., within a threshold distance of the route, of a particular size, etc.) may provide a candidate location for an intermediate point at which additional map data may be scheduled to be downloaded.

With reference to the second route 802b, a different manner of data download scheduling may be used than those discussed with reference to first route 802a. For example, upon determining that a number of white spots along route 802b is below a threshold (e.g., the threshold and the number of white spots along the route being determined in one or more of the example methods described above (e.g., based on one or more of the above-described factors), one or more data downloads may be scheduled to occur as the device travels along the route 802b. For example, the scheduled data downloads may be regularly spaced and/or influenced by features of the route (e.g., proximity of white spots, condition/difficulty of route segments, time of day of entering route segments, total length of route, speed/projected speed of vehicle, user preferences, historical data regarding the route, etc.).

Intermediate points 812, 814, 816, and 818 may represent generally regularly spaced download locations at which map data may be downloaded. Portions of the route that extend only between two intermediate points (or between an intermediate point and a starting or destination point) may be referred to herein as route segments. Upon entering starting point 804b (e.g., while located at starting point 804b), a device may be controlled to download a first set of map data. The first set of map data may be smaller than the set of map data downloaded while located at starting point 804a (e.g., as discussed above), and may correspond to one or more of the route segments located after starting point 804b. For example, the map data may correspond to map data within a threshold distance of route 802b only between starting point 804b and intermediate point 812. In such an example, only map data for one segment at a time may be downloaded. In other examples, map data for two or more segments may be downloaded at a time (e.g., at a given point along the route). For example, the map data downloaded at starting point 804b may correspond to map data for the route segment between starting point 804b and intermediate point 812 as well as map data for the route segment between intermediate point 812 and intermediate point 814. The number of segments for which map data is downloaded may be based on user preferences, vehicle speed/predicted speed, number of white spots along the route/route segments, historical data, total length of the route, length of the route segments, available memory on the device, etc.). As the vehicle proceeds to a next point on the route (e.g., from starting point 804b to intermediate point 812), map data for at least one additional route segment may be downloaded responsive to (e.g., while located at) the next point (e.g., intermediate point 812).

One or more booster download locations may be scheduled/configured based on features of the route. For example, intermediate point 820 may represent a booster download in order to ensure that map data is downloaded before entering white spot 808b. For example, a map data download may be scheduled to occur when the device reaches intermediate point 820 due to the intersection of white spot 808b with the route. In other examples, downloads may be scheduled for locations on the route within a threshold distance of a white spot that has a threshold size, a white spot that has a threshold proximity to the route, a threshold number of white spots within a threshold proximity of the route, etc. In some examples, the map data downloaded at intermediate point 820 may be at least partially overlapping with the map data downloaded at intermediate point 814.

Although the invention has been illustrated and described with respect to several preferred embodiments thereof, various changes, omissions and additions to the form and detail thereof, may be made therein, without departing from the spirit and scope of the invention. The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the in-vehicle computing system 109/200 described with reference to FIGS. 1 and 2 and/or the navigational system 10 of FIGS. 3 and 4. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The systems and methods described above also provide for a navigation system that caches map data associated with wireless white spots, the system comprising map data memory, a position sensor that determines a present location of the navigation system and provides navigation system position data indicative thereof; a wireless transmitter that transmits the navigation system position data, a wireless receiver that receives wireless data including wireless white spot map data and wireless non-white spot map data in response to the transmitted navigation system position data and stores the received wireless white spot map data and the wireless non-white spot map data in the map data memory, and a processor that receives the navigation system position signal and forms a map image based upon the received wireless white spot map data and the navigation system position data when the wireless receiver is not receiving the wireless data. In a first example of the navigation system, forming the map image may additionally or alternatively be based upon the wireless non-white spot map data when the wireless receiver has established a wireless communication channel to receive the wireless data. A second example of the navigation system optionally includes the first example and further includes wherein wireless receiver receives wireless white spot location data. A third example of the navigation system optionally includes one or more of the first and the second examples, and further includes wherein the processor forms the map image based upon the received wireless white spot map data when the navigation system position signal indicates that the navigation system is within the area defined as a wireless white spot based upon the wireless white spot location data. A fourth example of the navigation system optionally includes one or more of the first through the third examples, and further comprises a route guidance unit that provides turn by turn guidance based upon the navigation system position signal and route calculation information. A fifth example of the navigation system optionally includes one or more of the first through the fourth examples, and further includes wherein the route calculation information is processed by a route calculation unit located in one or more of a navigation data server and the processor. A sixth example of the navigation system optionally includes one or more of the first through the fifth examples, and further includes wherein the route calculation information is received by the wireless receiver from the route calculation unit located in the navigation data server and provided to the route guidance unit when a data connection between the processor and the navigation data server exists. A seventh example of the navigation system optionally includes one or more of the first through the sixth examples, and further includes wherein the route calculation information is determined by the route calculation unit in the processor when the data connection between the processor and the navigation data server does not exist and provided to the route guidance unit.

The systems and methods described above also provide for a method of caching, in a navigation system map data memory device, navigation content that is associated with cellular white spots, the method comprising determining a present location of the navigation system and providing a vehicle position signal indicative thereof; wirelessly transmitting the navigation system position data, wirelessly receiving cellular data that comprises cellular white spot map data and cellular non-white spot map data in response to the transmitted navigation system position data, and storing the received cellular white spot map data and the cellular non-white spot map data in the map data memory device, and forming a map image based upon received cellular white spot map data and the navigation system position signal, when the wireless receiver is in a cellular white spot. In a first example of the method, responsive to wirelessly receiving cellular white spot location data, the method may additionally or alternatively form the map image based upon the received cellular white spot map data when the vehicle position signal indicates that the motor vehicle is within an area defined as a cellular white spot based upon the cellular white spot location data. A second example of the method optionally includes the first example, and further includes downloading a first, smaller set of map data associated with fewer white spot location data for a known location. A second example of the method optionally includes the first example, and further includes wherein the known location is further based on one or more of a starting location, day, and time of day. A third example of the method optionally includes one or more of the first and the second examples, and further includes downloading a second, larger set of white spots surrounding current location for one or more of an unknown location and an unknown destination. A fourth example of the method optionally includes one or more of the first through the third examples, and further includes wherein the map data associated with known white spots is available to client map memory for subsequent trips until overwritten. A fifth example of the method optionally includes one or more of the first through fourth examples, and further includes wherein an amount of map data downloaded is based on one or more of a size of client side memory devices and an expected cost associated with downloading map data from server.

The systems and methods described above also provide for an in-vehicle computing system comprising one or more sensors, a network interface coupled to a cloud-based map database, a user input interface configured to receive user input from one or more user input devices, a processor, and a storage device storing map data and instructions executable by the processor to determine a current location based on inputs from the one or more sensors, receive a destination input from a user via the one or more user input devices, determine a route based on the current location and the destination, generate a map image of the route, determine a number of white spots along the route, and download white spot map data, an amount of white spot map data that is downloaded being based on the number of white spots along the route. In a first example of the in-vehicle computing system, the white spots may additionally or alternatively include regions having cellular network coverage below a threshold. A second example of the in-vehicle computing system optionally includes the first example and further includes wherein downloading white spot map data further comprises downloading a first, smaller set of map data when the number of white spots is below a threshold and downloading a second, larger set of map data when the number of white spots is greater than the threshold. A third example of the in-vehicle computing system optionally includes one or more of the first and the second examples and further includes wherein the map image further comprises a plurality of tiles centered around a map of the current location. A fourth example of the in-vehicle computing system optionally includes one or more of the first through the third examples, and further includes wherein the plurality of tiles are cached in the white spot map data at a zoom level used for turn by turn navigation based on a data usage and a navigation device memory size.

The systems and methods described above also provide for a navigation device that caches map data associated with cellular white spots, the device comprising map data memory, a sensor that determines a present location of the navigation device and provides a navigation device position data indicative thereof, a cellular telephony transmitter that transmits the navigation system position data, a cellular telephony receiver that receives data including cellular white spot map data and cellular non-white spot map data in response to the transmitted navigation system position data and stores the received cellular white spot map data and the cellular non-white spot map data in the map data memory, and a processor that receives the navigation system position signal and forms a map image based upon the received cellular white spot map data and the navigation system position data when the present current location of the wireless receiver is within a cellular white spot. In a first example of the navigation device, the device may additionally or alternatively include receiving the navigation system position signal and forming a map image based upon the received cellular non-white spot map data and the navigation system position data when the present current location of the wireless receiver is not within a cellular white spot. A second example of the navigation device optionally includes the first example, and further includes wherein the map image further comprises plurality of tiles centered around the navigation system position signal. A third example of the navigation device optionally includes one or more of the first and the second examples, and further includes wherein the plurality of tiles are cached in the white spot at a zoom level used for turn by turn navigation based on a data usage and a navigation device memory size. A fourth example of the navigation device optionally includes one or more of the first through the third examples, and further includes wherein the tile comprises map data indicative of an associated coordinate.

The systems and methods described above also provide for a method of caching, in a navigation device, the method comprising determining a current location based on inputs from plurality of sensors, receiving a destination input from a user via plurality of devices, determining a route based on the current location and the destination, generating a map image of the route, determining number of white spots along the route, and downloading white spot map data based on the number of white spots along the route. In a first example of the method, the method may additionally or alternatively include wherein the white spots comprise of areas of cellular coverage below a threshold. A second example of the method optionally includes the first example, and further includes wherein downloading white spot data further comprises downloading a first, smaller set of map data when the number of white spots is below a threshold and downloading a second, larger set of map data when the number of white spots is greater than the threshold. A third example of the method optionally includes one or more of the first and the second examples, and further includes wherein the second, larger set of map data includes at least a portion of the first, smaller set of map data and additional map data that is not included in the first, smaller set of map data. A fourth example of the method optionally includes one or more of the first through the third examples, and further includes wherein the map image further comprises plurality of tiles centered around the current location. A fifth example of the method optionally includes one or more of the first through the fourth examples, and further includes wherein the plurality of tiles are cached in the white spot map data at a zoom level used for turn by turn navigation based on a data usage and a navigation device memory size.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A navigation system that caches map data associated with wireless white spots, the system comprising:
map data memory;
a position sensor that determines a present location of the navigation system and provides navigation system position data indicative thereof;
a wireless transmitter that transmits the navigation system position data;
a wireless receiver that receives wireless data including wireless white spot map data and wireless non-white spot map data in response to the transmitted navigation system position data and stores the received wireless white spot map data and the wireless non-white spot map data in the map data memory; and
a processor that receives the navigation system position signal and forms a map image based upon the received wireless white spot map data and the navigation system position data when the wireless receiver is not receiving the wireless data.

2. The navigation system of claim 1, wherein the processor forms the map image based upon the wireless non-white spot map data when the wireless receiver has established a wireless communication channel to receive the wireless data.

3. The navigation system of claim 1, wherein wireless receiver receives wireless white spot location data.

4. The navigation system of claim 1, wherein the processor forms the map image based upon the received wireless white spot map data when the navigation system position signal indicates that the navigation system is within the area defined as a wireless white spot based upon the wireless white spot location data.

5. The navigation system of claim 1, further comprising a route guidance unit that provides turn by turn guidance based upon the navigation system position signal and route calculation information.

6. The navigation system of claim 5, wherein the route calculation information is processed by a route calculation unit located in one or more of a navigation data server and the processor.

7. The navigation system of claim 6, wherein the route calculation information is received by the wireless receiver from the route calculation unit located in the navigation data server and provided to the route guidance unit when a data connection between the processor and the navigation data server exists.

8. The navigation system of claim 7, wherein the route calculation information is determined by the route calculation unit in the processor when the data connection between the processor and the navigation data server does not exist and provided to the route guidance unit.

9. A method of caching, in a navigation system map data memory device, navigation content that is associated with cellular white spots, the method comprising:
determining a present location of the navigation system and providing a vehicle position signal indicative thereof;
wirelessly transmitting the navigation system position data;
wirelessly receiving cellular data that comprises cellular white spot map data and cellular non-white spot map data in response to the transmitted navigation system position data, and storing the received cellular white spot map data and the cellular non-white spot map data in the map data memory device; and
forming a map image based upon received cellular white spot map data and the navigation system position signal, when the wireless receiver is in a cellular white spot.

10. The method of claim 9, further comprising wirelessly receiving cellular white spot location data, and forming the map image based upon the received cellular white spot map data when the vehicle position signal indicates that the motor vehicle is within an area defined as a cellular white spot based upon the cellular white spot location data.

11. The method of claim 10, further comprising downloading a first, smaller set of map data associated with fewer white spot location data for a known location.

12. The method of claim 11, wherein the known location is further based on one or more of a starting location, day, and time of day.

13. The method of claim 11, further comprising downloading a second, larger set of white spots surrounding current location for one or more of an unknown location and an unknown destination.

14. The method of claim 13, wherein the map data associated with known white spots is available to client map memory for subsequent trips until overwritten.

15. The method of claim 14, wherein an amount of map data downloaded is based on one or more of a size of client side memory devices and an expected cost associated with downloading map data from server.

16. An in-vehicle computing system comprising:
one or more sensors;
a network interface coupled to a cloud-based map database;
a user input interface configured to receive user input from one or more user input devices;
a processor; and
a storage device storing map data and instructions executable by the processor to:
determine a current location based on inputs from the one or more sensors;
receive a destination input from a user via the one or more user input devices;
determine a route based on the current location and the destination;
generate a map image of the route;
determine a number of white spots along the route; and
download white spot map data, an amount of white spot map data that is downloaded being based on the number of white spots along the route.

17. The in-vehicle computing system of claim 16, wherein the white spots include regions having cellular network coverage below a threshold.

18. The in-vehicle computing system of claim 16, wherein downloading white spot map data further comprises downloading a first, smaller set of map data when the number of white spots is below a threshold and downloading a second, larger set of map data when the number of white spots is greater than the threshold.

19. The in-vehicle computing system of claim 16, wherein the map image further comprises a plurality of tiles centered around a map of the current location.

20. The in-vehicle computing system of claim 19, wherein the plurality of tiles are cached in the white spot map data at a zoom level used for turn by turn navigation based on a data usage and a navigation device memory size.
